(19) United States
(12) Patent Application Publication
(10) Pub. No.: US 2015/0359201 A1
(43) Pub. Date: Dec. 17, 2015

(54) Methods and Apparatus for Tracking and Analyzing Animal Behaviors

(71) Applicant: Chris Kong, Beijing (CN)

(72) Inventor: Chris Kong, Beijing (CN)

(21) Appl. No.: 14/600,231

(22) Filed: Jan. 20, 2015

Related U.S. Application Data
(60) Provisional application No. 62/010,642, filed on Jun. 11, 2014.

(51) Int. Cl. A01K 29/00; G06K 9/00; G06T 7/20; G06T 7/00; G06F 17/30

(52) U.S. Cl. CPC A01K 29/005; G06T 7/0004; G06F 17/3028; G06T 7/20; G06K 9/00624

(57) ABSTRACT

Described herein are methods and systems for tracking and analyzing animal behaviors. Specifically, certain animal data, such as animal motions of interest (running, walking, resting, playing), are captured through a device attached to the animal. Such data can be locally processed and stored or periodically uploaded into servers or cloud storage for further processing to generate animal reports or sickness notifications for the pet owner to view via an animal tracking and viewing application in a user terminal device.

### PRIORITY CLAIM AND CROSS-REFERENCE OF RELATED APPLICATIONS

This application claims priority to the provisional application No. 62/010,642, filed on Jun. 11, 2014, which is hereby incorporated by reference in its entirety.

### FIELD OF THE INVENTION

The present invention relates generally to enhancing pet owners' interactions with their pets and awareness of their pets' behavior patterns, and more particularly, to methods and systems configured to track pet behaviors and analyze animal data derived therefrom so that pet owners are provided with timely information about their pets, such as periodic activity reports, illness alerts, interesting photos and videos.

### BACKGROUND

Many pet owners may have experienced the situation where their pets had been sick for days before any illness symptom became noticable. Oftentimes such illness may find indications from certain abnormal behavior or activity pattern of the pets, for example, the pet could be overly active or extremely inactive. However, such behavior change tends to be neglected by most pet owners, especially when they do not have enough interaction with their pets on the daily basis. Therefore, there is a need to provide pet owners with timely information about their pets, such as the pets' behavior reports, photos or videos of certain pre-defined interests, and so forth, so that any existing or potenial illness of the pets can be detected and fixed in a timely manner.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

One embodiment is directed to a method for tracking and analyzing animal behavior, comprising: capturing animal data from a device attached to an animal, said device configured for monitoring animal behavior; uploading said animal data from said device to one or more web-based server, wherein one or more animal reports are generated based on said animal data, said animal reports showing an activity pattern of the animal.

In one embodiment, the present invention is directed to a method for animal visualization, comprising: capturing animal data from a device attached to an animal, said device configure for monitoring animal behavior; recognizing one or more motions of interest from said animal data; based on said recognized motions of interest, determining to capture an image of the animal; and processing said captured image with contextual information to generate an animal visualization, said contextual information comprising at least an activity pattern associated with the animal.

Another embodiment is directed to a device comprising: one or more motion sensors for capturing animal data from an animal; a memory comprising executable instructions; and a processor configured to execute the executable instructions in the memory, wherein the executable instructions, while executed, cause the processor to perform: receiving the captured animal data; recognizing one or more motions of interest from said animal data; and generating time series of data.

Yet another embodiment is directed to a non-transitory computer-readable medium comprising executable instructions, which, while executed, causing the processor to perform: receiving time series of animal data captured by a device configured for monitoring animal behavior, said time series of animal data comprising raw accelerometer and gyroscope data; classifying said time series of animal data into a set of animal activities; generating time series of animal activities; and generating animal activity reports based on the time series of animal activities.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a high-level overview of an exemplary system in which embodiments of the invention can be implemented;

FIG. 2 is a block diagram of an exemplary animal monitoring device in which embodiments of the invention can be implemented;

FIG. 3A-B illustrate an exemplary process for capturing and processing animal data in the device of FIG. 2 according to embodiments of the invention;

FIGS. 4A-B illustrate an exemplary process for animal motion recognition and control in the device of FIG. 2 according to embodiments of the invention;

FIG. 5A-E illustrate an exemplary animal data processing algorithm and select exemplary animal reports according to embodiments of the invention;

FIG. 6 is a block diagram illustrating an exemplary animal tracking application according to embodiments of the invention;

FIG. 7 is a simplified functional block diagram of an exemplary computer that can be implemented in the exemplary system of FIG. 1; and

FIG. 8 is a simplified functional block diagram of an exemplary mobile device that can be implemented in the exemplary system of FIG. 1.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, embodiments of the present invention are not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Embodiments disclosed herein are directed to methods and systems for tracking and analyzing animal behaviors. Specifically, animal data, such as animal motions of interest (running, walking, resting, playing), are captured through a device attached to the animal. Such data can be locally processed and stored or periodically uploaded into servers or cloud storage for further processing, including, without limitation, generating certain reports or sickness notifications for the pet owner, which can be viewed via an animal tracking and viewing application in a user terminal device. In one embodiment, such animal data include one or more animal images (in the photo or video form) to be further visualized in connection with contextual information, such as an activity pattern of the animal, a motion intensity, other auxiliary information, and so forth.

As partial implementation of the embodiments, a device is configured to track and monitor animal activities, which comprises one or more motion sensors such as an accelerometer, a gyroscope or an IMU (Inertial Measurement Unit) for sensing animal motions, a camera/video recorder for capturing animal photos or videos, and associated control and communication modules embodied in software and/or firmware. In one embodiment, an animal data processing algorithm is implemented in the cloud for analyzing the animal data collected by the device attached to the animal. In another embodiment, an animal tracking application is implemented in a user terminal device, such as a mobile phone, a tablet, a notebook, or a personal computer, to provide animal data to a pet owner in a timely and user-friendly fashion.

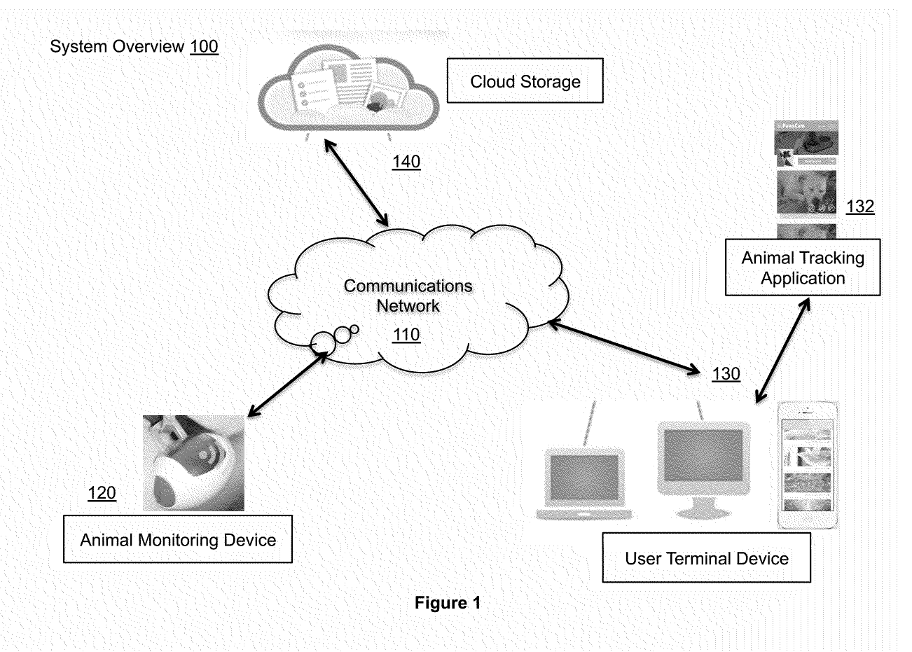

Referring to FIG. 1, illustrated therein is a high-level overview of an exemplary system 100 in which embodiments of the invention can be implemented. As shown in FIG. 1, the system 100 comprises a communications network 110 and a few entities connected to the network, including one or more animal monitoring devices 120, one or more user terminal devices 130 and cloud storage 140.

The communication network 110 can be one or a combination of the following networks: the Internet, Ethernet, a mobile carrier's core network (e.g., AT&T or Verizon networks), a Public Switched Telephone Network (PSTN), a Radio Access Network (RAN), and any other wired or wireless networks, such as a WiFi (e.g., Bluetooth or Zigbee) or any home network.

The animal monitoring device 120 is configured to capture and store animal motion data, such as raw accelerometer and gyroscope data, photo image data, etc. In one embodiment, the device includes one or more motion sensors comprising an accelerometer for measuring acceleration, a gyroscope for measuring orientation, or a combination thereof, which is sometimes referred as Inertial Measurement Unit (IMU). In practice, this device 120 is attached to an animal of interest, such as a dog, cat or any other pet to be monitored. Whenever a pre-defined motion of interest (e.g., running, walking, playing, resting) is detected, raw accelerometer and gyroscope data is captured and stored locally in the device 120. In some circumstances, such motion detection may also trigger a photo shoot or video recording of the animal behavior, and such image data is also stored. Typically, the device 120 is configured to communicate with cloud storage 140 wirelessly via the communication network 110. For example, the data stored in the device may be uploaded into the cloud storage periodically, e.g., once a day, or whenever the WiFi signal is available.

The cloud storage 140 usually comprises multiple web servers configured to store large amounts of data from difference data resources. In one configuration, at least one back-end server in the cloud storage is programmed with a data processing algorithm or web-based application for analyzing and processing the raw animal data (e.g., accelerometer, gyroscope, photo images, etc.) uploaded from the animal monitoring device 120. Such data processing algorithm combines the raw animal data with other relevant data, such as time information, to generate useful data analyses and reports for pet owners. For instance, one such report can show the pet owners their pets' behavior patterns, any abnormal activities, or indications of existing or potential sickness.

Any animal-related data analyses and reports generated in the cloud storage 140 can either remain in the cloud or be transmitted to one or more user terminal devices 130. As illustrated in FIG. 1, such user terminal devices 130 may comprise various smart phones such as iPhone, Android phones, and Windows phones. However, the devices 130 are not so limited, but may include many other network devices, including a fixed or mobile subscriber unit, a pager, a cellular telephone, a personal digital assistant (PDA), a smart phone, a laptop, a netbook, a tablet computer, a personal computer, a wireless sensor, consumer electronic devices, and the like.

The terminal device 130 is configured with computer software, executable programs, algorithms, functional modules and processes, such as the animal tracking application 132 (e.g., a “PawsCam” App as illustrated in FIG. 1) for receiving animal information, including animal photos and videos, animal reports, and alerts based on animal behaviors. As will be described in detail below, the application 132 allows a pet owner to keep track of his pet's activity pattern on an almost real-time basis. The application 132 can be downloaded and installed in any mobile device from a website, an App Store typical of iPhones, or any application utility provided by Android phones, Windows phones or any other mobile devices. In practice, various versions and updates of the application 132 can be provided in order to be compatible with different mobile operating systems such as Apple iOS, Android or Windows.

It should be appreciated that the system 100 in FIG. 1 is for illustration only and can be implemented with many variations without departing from the spirit of the invention. For instance, the cloud storage 140 may include multiple computers and stations distributed in different locations.

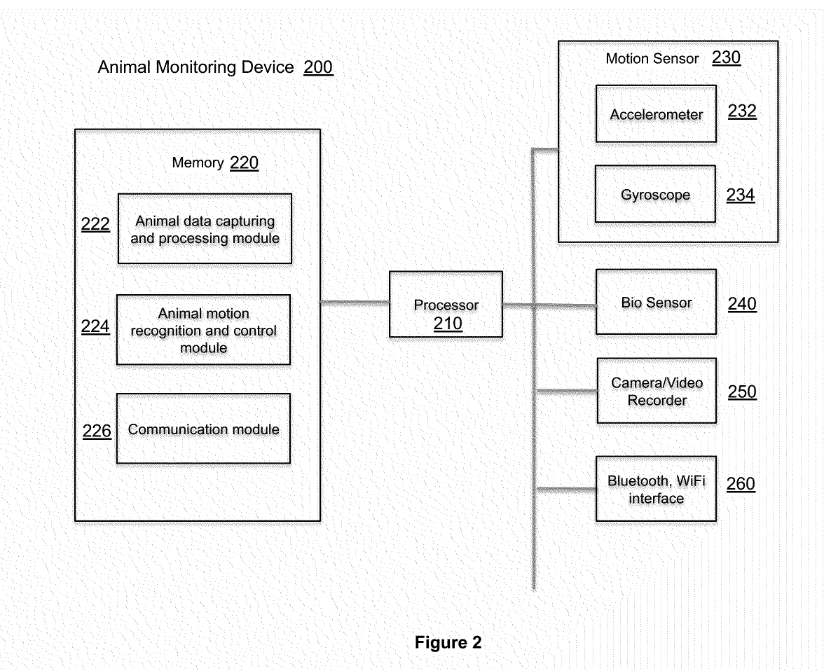

FIG. 2 is a block diagram of an exemplary animal monitoring device in which embodiments of the invention can be implemented. As shown in FIG. 2, the animal monitoring device 200 comprises a processor 210, a memory 220 accessible to the processor 210, and a few other entities configured to communicate with the processor 210, including one or more motion sensors 230, a bio sensor 240, a camera and/or video recorder 250, and a Bluetooth or WiFi interface 260. It should be understood that FIG. 2 only presents a simplified diagram and many other components (not shown) may be integrated in the animal monitoring device 200.

Also, while the memory 220 is shown as being separate from the processor 210, all or a portion of the memory 220 may be embedded in the processor 210. In some embodiments, the memory 220 stores various programs, modules and data structures, or a subset thereof. As shown in FIG. 2, the memory 220 stores an animal data capturing and processing module 222, an animal motion recognition and control module 224, and a communication module 226. For illustration purposes, these modules are shown as separate, but in actual implementations, they can be integrated into one software application or further divided into different sub-modules. In practice, the processor 210 is configured to execute the modules stored in the memory 220 to accomplish various functions of the device 200, as will be described in detail below.

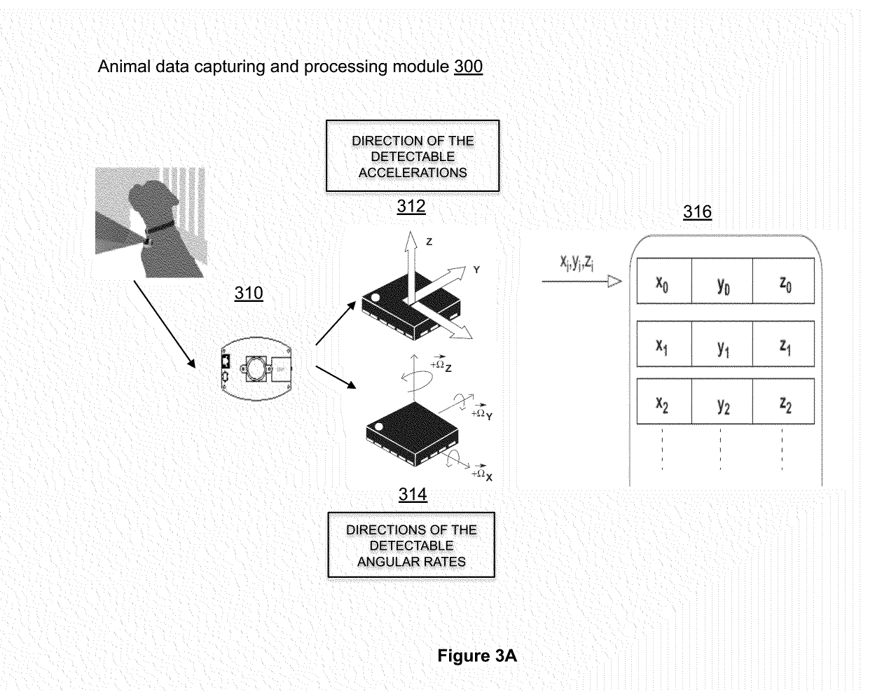

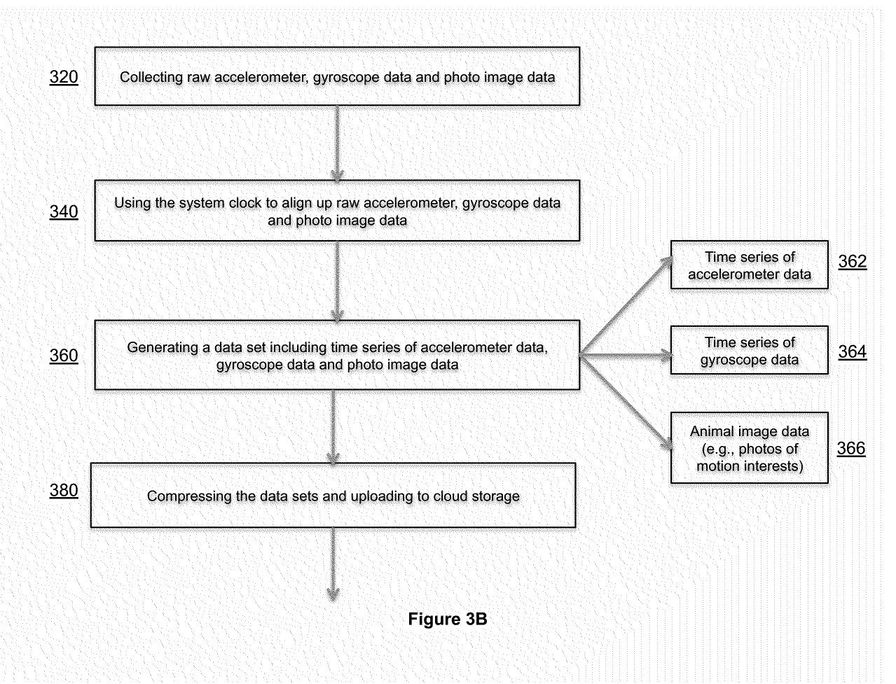

FIG. 3A-B illustrate an exemplary process for capturing and processing animal data in the animal monitoring device according to embodiments of the invention. As seen in FIG. 3A, the animal data capturing and processing module 300 is implemented, largely depending on two components in the animal monitoring device 310: an accelerometer 312 and a gyroscope 314. In certain configurations, the two components can be combined into an IMU, or combined with additional magnetometers. The accelerometer 312 measures accelerations of the device in different directions: x, y and z. The measured results, as shown in the chart 316, include x, y, z accelerations at each time increment: (x₀, y₀, z₀), (x₁, y₁, z₁) . . . (xₙ, yₙ, zₙ), wherein 0, 1, . . . n represent time increments. The gyroscope 314 further measures detectable angular rates in x, y, z directions. All data captured by the accelerometer 312 and gyroscope 314 will be processed and analyzed following an algorithm such as shown in FIG. 3B.

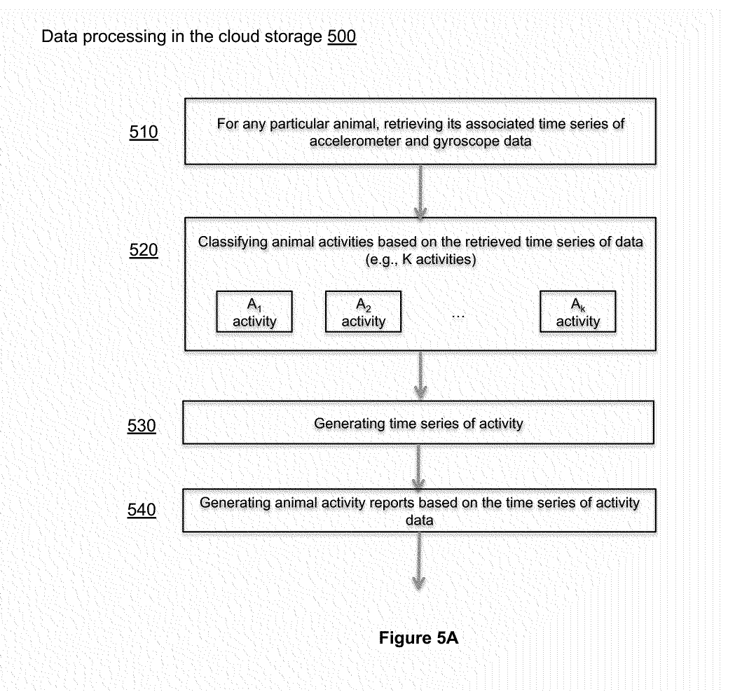

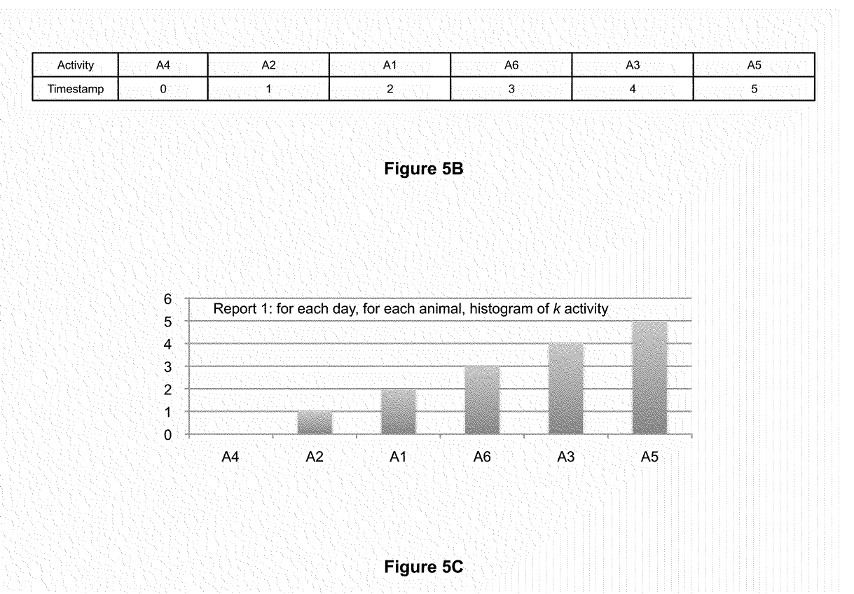

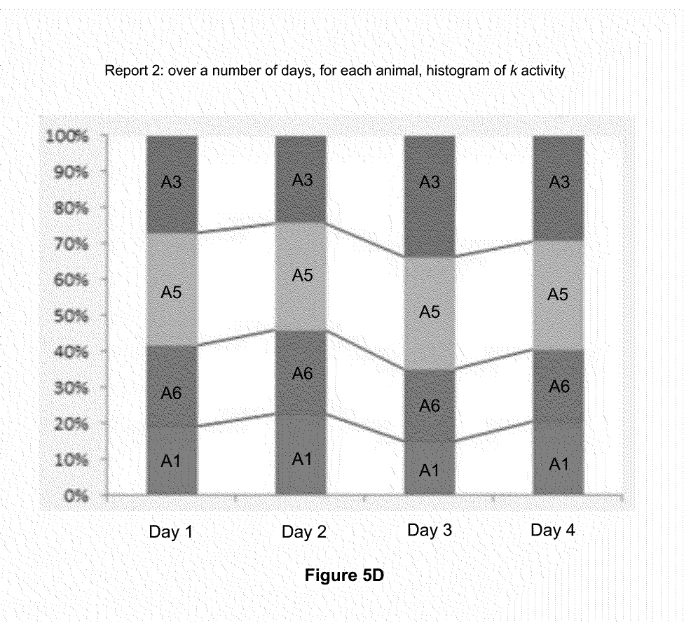

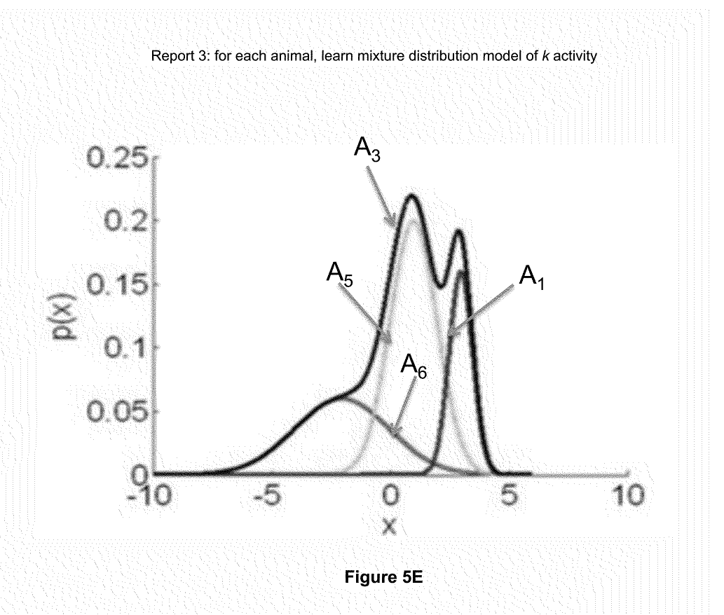

In FIG. 3B, an exemplary algorithm for animal data processing in the device 310 starts at step 320, in which raw accelerometer and gyroscope data, in addition to animal photo and/or video data, are collected. At step 340, all these data are time aligned using a clock in the device. As a result, at step 360, a data set is generated, which includes time series of different data: time series of accelerometer data 362, time series of gyroscope data 364 and time series of image data 366 (in the photo or video format). At step 380, such data sets are compressed and uploaded into the cloud automatically. As will be described in detail with reference to FIG. 5A-E, such data sets provide a basis for generating data analyses and reports in the cloud.

It should be appreciated that the above-described algorithm is for illustration only, and many variations or additional steps may be applied. For example, additional features or functions can be added in the animal monitoring device.

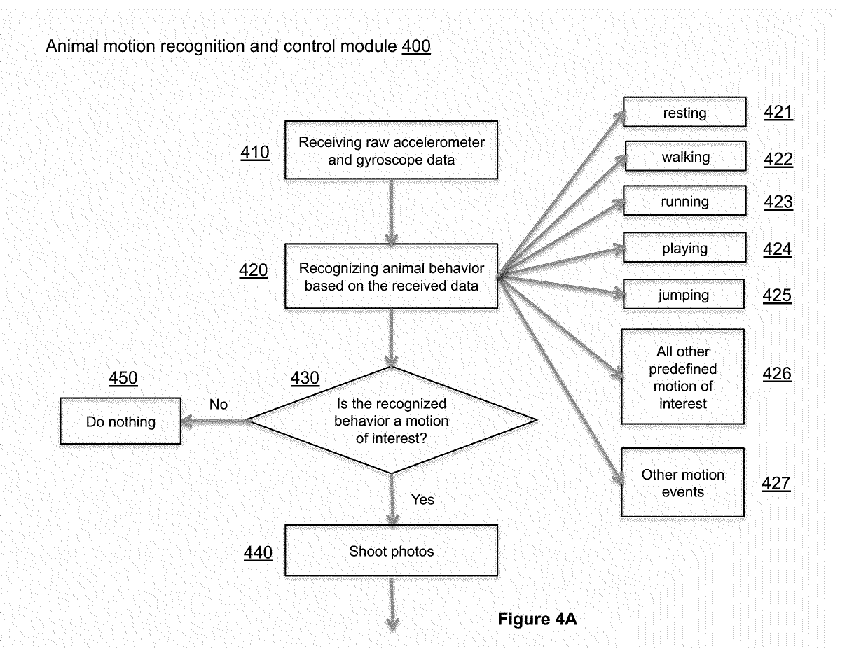

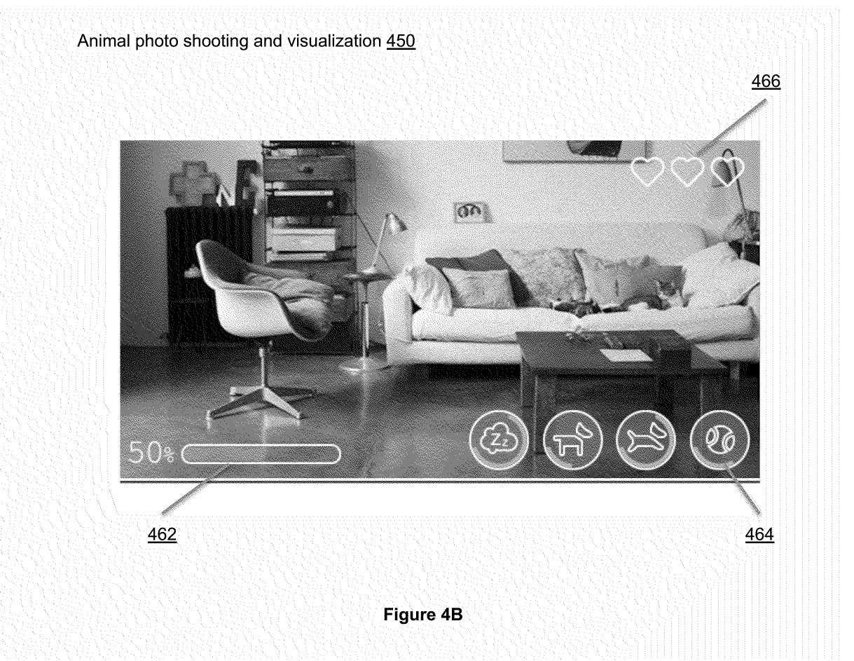

FIGS. 4A-B illustrate an exemplary process for animal motion recognition and control in the animal monitoring device according to embodiments of the invention. As shown in FIG. 4A, the process starts at step 410 when raw accelerometer and gyroscope data are received. Based on such received data, the device can recognize certain animal behaviors at step 420. For example, certain data may suggest that the animal is resting 421, walking 422, running 423, playing 424 or jumping 425. Besides, other motions of interest 426 can be identified from the received raw data. For example, a pet owner may be particularly interested in observing his pet's eating pattern or sleeping pattern, and can thus pre-define certain motions of interest to be monitored. In addition, other motion events 427 can be included in this step of analyzing and recognizing animal motions.

Once the animal behavior is recognized, the device determines, at step 430, whether the recognized behavior is a motion of interest to be photographed or video recorded. If so, the process proceeds to step 440, where the camera or video recorder is activated to perform a photo or video taking task. If the recognized behavior is outside any motion of interest, then the process proceeds to step 450 where nothing needs to be done.

In one embodiment, if an animal photo is taken in the above-described process, the resulting photo image can be further processed for an improved visualization, as demonstrated in FIG. 4B. In the case of animal photo shooting and visualization 460, a reality or fusion camera system can be used for augmented reality associated with the animal. For example, the captured image data can be augmented or improved with reality information such as a motion intensity 462 of the animal as of the moment the photo image was taken, an activity pattern 464 of the animal, any other auxiliary information 466, and so on. The resulting visualization of the animal can be presented to the pet owner via a display terminal.

Again, it should be appreciated that the above-described algorithm is for illustration only, and many variations or additional steps may be applied.

FIG. 5A-E illustrate an exemplary data processing algorithm and select exemplary animal reports according to embodiments of the invention. As aforementioned in FIG. 3B, time series of data are compressed and uploaded into cloud for further processing, and FIG. 5A illustrates such a data processing algorithm 500 in the cloud.

Take one particular animal or pet for example. As seen in FIG. 5A, the process starts at step 510 where all times series of data (e.g., accelerometer, gyroscope data) associated with this particular animal would be retrieved. At step 520, based on the retrieved data, the activities performed by this animal can be classified. For instance, the animal has done K types of activities, and as a result, its associated activities can be classified into A₁, A₂ . . . Aₖ activity. Thereafter, at step 530, time series of activity can be generated. For example, as illustrated in FIG. 5B, at different time stamps 0, 1, 2, 3, 4, 5, the corresponding animal activity is A₄, A₂, A₁, A₆, A₃, A₅, respectively.

Based on the time series of activity data, at step 540, various animal activity reports can be generated. For example, FIG. 5C presents a report showing an animal's histogram of K activity in one day. As seen in this report, amongst all the animal activities, activity A₅ (e.g., walking) is more frequent than others. FIG. 5D presents a different report showing an animal's histogram of K activity over a few days. In this report, the frequency of different animal activities may vary with the time periods, depending on whether the pet behaves normal or not. For example, for a monitored time period from Day 1 to Day 4, the change in the frequency of certain activities, such as A₃ (e.g., sleeping), can be signs of abnormal pet behaviors. On Day 3, the sudden increase of activity A₃ (e.g., sleeping) may indicate the pet is getting sick. FIG. 5E presents a mixed distribution model of the animal's K activities. For example, a Gaussian mixture model may be used to show probability distributions of the animal's activities, such as A₅, A₁, A₆, A₃. As seen in FIG. 5E, activity A₅ has a normal distribution, while activity A₃ does not, which statistically indicates sickness in the pet. From such reports, pet owners can observe any changes in their pets' activity pattern, which can indicate any sickness or abnormality of the pets.

It should be appreciated that the above-mentioned reports are for demonstration only, and many variations or modifications can be implemented in terms of specific animal reports and results of interest to the pet owners.

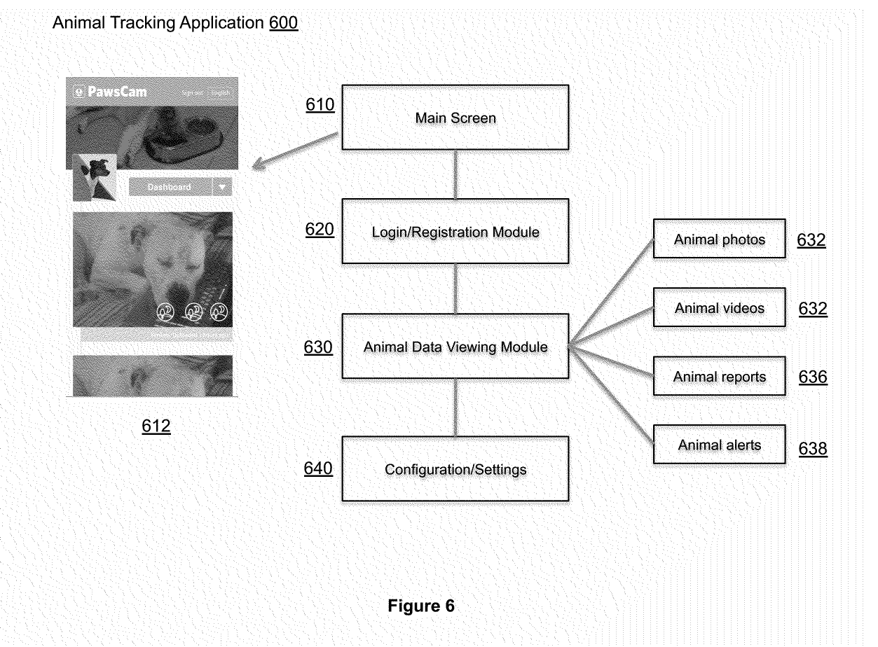

FIG. 6 is a block diagram illustrating an exemplary animal tracking application 600 according to embodiments of the invention. Such an application can be downloaded and installed in a user terminal device, such as a smart phone, tablet computer or personal computer. As shown in FIG. 6, the application can comprise a main screen 610 as the primary user interface (such as the screen shot 612), a login or registration module 620 for users to manage their profile or account information, an animal viewing module 630 that integrates most functions of the application, and a configuration or settings module 640. In one embodiment, the animal viewing module 630 allows a user to view animal photos 632 or animal videos 634, and receive animal reports 636 or animal alerts 638.

It should be understood that FIG. 6 is for illustration only, and many functions or features can be added in the animal tracking application. Also, the screen shot in the above-described figures is for illustration only, and can include many other variations in actual implementations. For example, depending on the operating systems of a user's smart phone (e.g., IOS for iPhone, Android, Windows, etc.), the screen shots may have different appearances, and the algorithm underlying the application may be coded very differently.

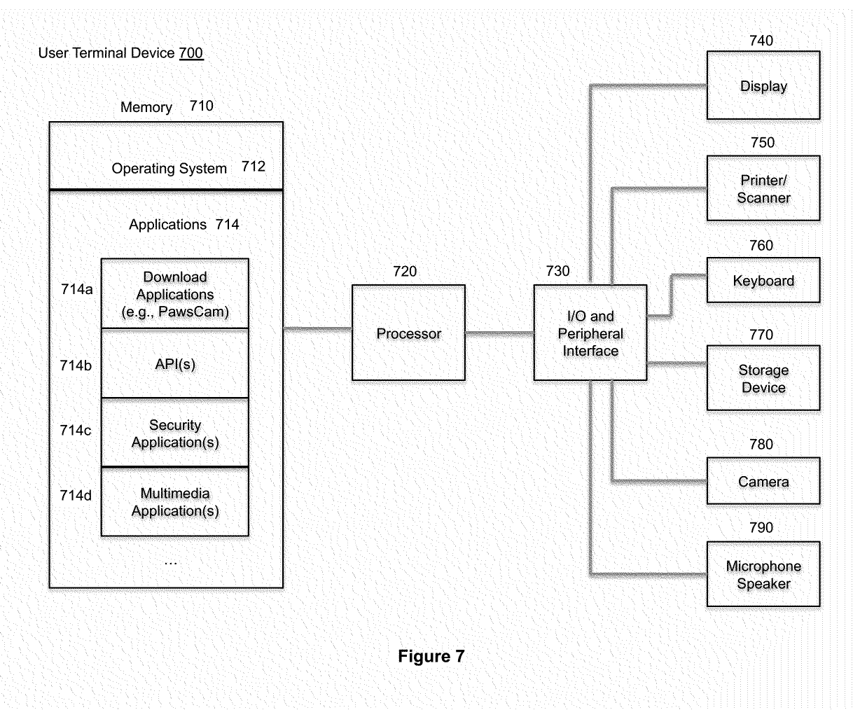

FIG. 7 is a simplified functional block diagram of an exemplary computer programmed or configured to execute a portion of the exemplary processes as described above. This exemplary computer 700 can also be implemented as one of the user terminal devices 130 in the exemplary system of FIG. 1. It should be noted that the computer 700 is for illustration only, and many computer components included therein may not be shown or described in the following paragraphs.

As shown in FIG. 7, the computer 700 comprises a memory 710, a processor 720 capable of accessing the memory 710, and one or more I/O interfaces or other peripheral interfaces 730 coupled to the processor 720. Exemplary external or peripheral devices include, without limitation, a display 740, a keyboard 760, a camera 780, a printer or scanner in a combined or separate form 750, a storage device 770 such as a USB or disk, and a microphone or speaker 790. The memory 710 includes software programs or drivers for activating and communicating with each peripheral device. In one configuration, these components are connected through one or more communication buses (not shown) in the computer, which may include circuitry that interconnects and controls communications between different components.

The memory 710 includes high-speed random access memory, such as DRAM, SRAM, DDR RAM and/or other random access solid state memory devices; and includes non-volatile memory, such as flash memory devices, a magnetic disk storage device, and/or other non-volatile solid state storage devices. The memory 710, or alternately non-volatile memory device(s) within the memory 710, includes a non-transitory computer-readable storage medium. While the memory 710 is shown as being separate from the processor 720, all or a portion of the memory 710 may be embedded in the processor 720. In some embodiments, the memory 710 stores the following programs, modules and data structures, or a subset thereof: an operating system 712 that includes procedures for handling various basic system services and for performing hardware dependent tasks, and applications 714, including one or more downloaded user applications 714a (e.g., the “PawsCam” application) and corresponding APIs 714b for processing data received from other devices and data to be transmitted to the other devices, security applications 714c, and/or multimedia applications 714d. In some embodiments, the non-transitory computer-readable storage medium of the memory 710 includes instructions for performing all or a portion of the operations in the exemplary processes as described above. The processor 720 is configured to access and execute the instructions, programs, applications, and modules stored in the memory 710.

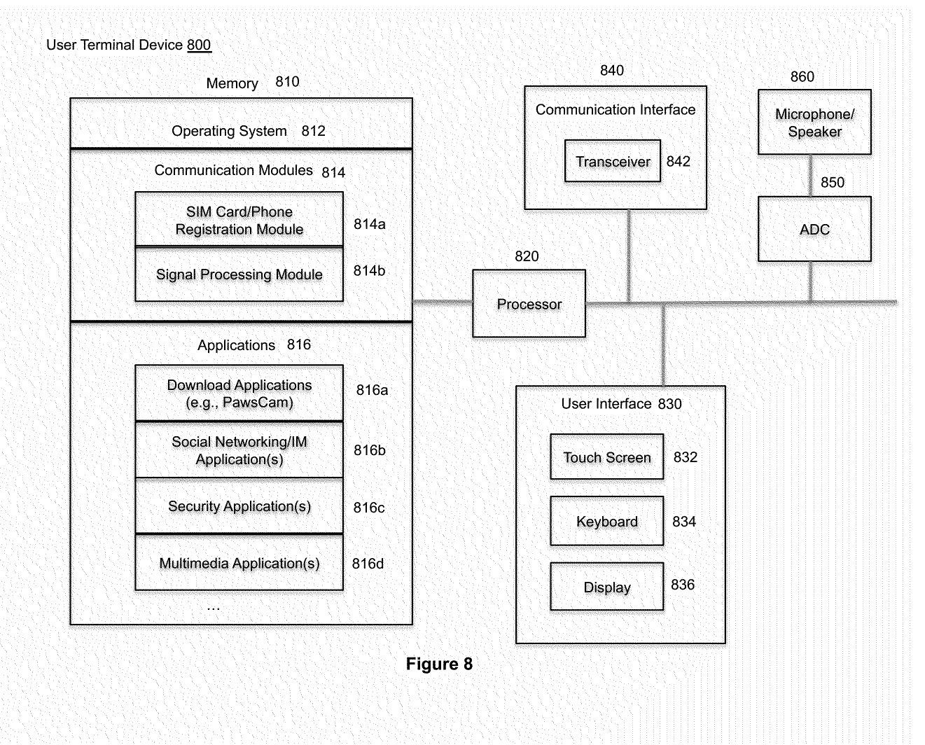

FIG. 8 is a simplified functional block diagram of an exemplary mobile device programmed or configured to execute a portion of the exemplary processes as described above. This exemplary mobile device 800 can also be implemented in the exemplary system of FIG. 1 for users to connect to the network and different application servers in the network. It should be noted that the device 800 is for illustration only, and many device components included therein may not be shown or described in the following paragraphs.

As shown in FIG. 8, the exemplary device 800 comprises a memory 810, a processor 820 capable of accessing the memory 810, a user interface 830, a communication interface 840, an Analog to Digital Converter (ADC) 850 and a microphone or speaker 860 connected to the ADC. In one configuration, all device components are connected through one or more communication buses (not shown) that may include circuitry that interconnects and controls communications between different components.

The memory 810 includes high-speed random access memory, such as DRAM, SRAM, DDR RAM and/or other random access solid state memory devices; and includes non-volatile memory, such as flash memory devices, a magnetic disk storage device, and/or other non-volatile solid state storage devices. The memory 810, or alternately non-volatile memory device(s) within the memory 810, includes a non-transitory computer-readable storage medium. While the memory 810 is shown as being separate from the processor 820, all or a portion of the memory 810 may be embedded in the processor 820. In some embodiments, the memory 810 stores the following programs, modules and data structures, or a subset thereof: an operating system 812 that includes procedures for handling various basic system services and for performing hardware dependent tasks, communication modules 814 used for communicating with other devices or network controllers via the communications interface 840, such as a SIM card or phone registration module 814a and a signal processing module 814b, and applications 816, including one or more downloaded user applications 816a (such as the “PawsCam” App), various social network or messaging applications 816b, security applications 816c and multimedia applications 816d. All these applications may have associated API(s) (not shown) in the memory 810.

In some embodiments, the non-transitory computer-readable storage medium of the memory 810 includes instructions for performing all or a portion of the operations in the exemplary processes as described above. The processor 820 is configured to access and execute the instructions, programs, applications, and modules stored in the memory 810. Through the user interface 830, the processor 820 is coupled to one or more of the following: a touch screen 832, a keyboard 834 and a display 836. The processor 820 is also coupled to a transceiver 842 via the communication interface 840.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for tracking and analyzing animal behaviors, comprising:
capturing animal data from a device attached to an animal, wherein said device is configured for monitoring animal behaviors and communicating with one or more web-based servers in a cloud, said servers configured to generate one or more animal reports based on said animal data, said animal reports showing an activity pattern of the animal.

2. The method of claim 1, wherein said device comprises a camera, a video recorder, or a combination thereof.

3. The method of claim 2, wherein said animal data includes animal image data comprising a photo image of said animal and a video clip of said animal.

4. The method of claim 1, wherein said device comprises an accelerator, a gyroscope, or a combination thereof.

5. The method of claim 4, wherein said animal data includes raw accelerator data and gyroscope data associated with said animal.

6. The method of claim 1, further comprising recognizing one or more animal motions of interest based on said animal data.

7. The method of claim 6, wherein said device is configured to determined whether to take an action based on said recognized motions of interest.

8. The method of claim 6, further comprising:
aligning up said animal data in accordance with a system clock in said device; and
generating a data set comprising time series of said animal data.

9. The method of claim 8, further comprising compressing and uploading said time series of said animal data into said servers in the cloud.

10. The method of claim 9, wherein said servers are configured to classify animal activities based on said time series of said animal data and generate time series of activity data, said servers further configured to generate animal reports based on said time series of activity data.

11. The method of claim 1, further comprising providing said animal reports in a user terminal device installed with a mobile application, said user terminal device configured to communicate with said servers, and said mobile application allowing a user to view said animal reports.

12. A method for animal visualization, comprising:
capturing animal data from a device attached to an animal, said device configured for monitoring animal behaviors;
recognizing one or more motions of interest from said animal data;
based on said recognized motions of interest, determining whether to capture an image of said animal; and
processing said captured image in connection with contextual information to generate an animal visualization, said contextual information comprising at least an activity pattern of said animal.

13. The method of claim 12, wherein said image of said animal is captured by a camera or video recorder in said device.

14. The method of claim 12, wherein said device comprises an accelerator, a gyroscope or a combination of both for capturing said animal data.

15. A device for monitoring animal behaviors, comprising:
one or more motion sensors for capturing animal data from an animal;
a memory comprising executable instructions; and
a processor configured to execute said executable instructions in the memory, wherein said executable instructions, while executed, cause said processor to perform:
receiving said captured animal data;
recognizing one or more motions of interest from said animal data; and
uploading said captured animal data to one or more servers in a cloud.

16. The device of claim 15, further comprising an accelerator, a gyroscope, or a combination thereof.

17. The device of claim 15, wherein the processor is further configured to determine whether to take an action based on said recognized motions of interest.

18. The device of claim 15, wherein the processor is further configured for:
aligning up said animal data in accordance with a system clock in said device;
generating a data set comprising time series of said animal data; and
compressing and uploading said time series of said animal data to said servers in said cloud.

19. The device of claim 15, wherein said one or more servers generate animal reports based on said animal data and provide said animal reports in a user terminal.

20. A non-transitory computer-readable medium comprising executable instructions, which, while executed, causing the processor to perform:
receiving time series of animal data captured by a device configured for monitoring animal behaviors, said time series of animal data comprising raw accelerometer and gyroscope data;
classifying said time series of animal data into a set of animal activities;
generating time series of animal activities; and
generating animal activity reports based on the time series of animal activities.
